(19) United States
(12) Patent Application Publication
(10) Pub. No.: US 2003/0165143 A1
(43) Pub. Date: Sep. 4, 2003

(54) Switching method and network element

(76) Inventors: Rainer Jormanainen, Jokela (FI); Timo Harjunen, Helsinki (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/090,424

(22) Filed: Mar. 1, 2002

(51) Int. Cl. H04L 12/56

(52) U.S. Cl. 370/396; 370/395.64

(57) ABSTRACT

An incoming logical leg and an outgoing logical leg for a received call are defined using allocated identifications, and a switching operation for the received call is controlled on the basis of the incoming logical leg and the outgoing logical leg. Thus, physical resources of the switching network element are hidden from the visibility of the application layer and there is no need for different versions of applications in different switching techniques. Through switch connections through the switching network element thus consist of several subconnections terminated at service points where the payload and traffic parameters of the connection will change. The logical legs will change with the mobility of the user. The logical legs are managed by a leg control unit which controls the reservation of the service resources from corresponding resource management units and the cross-connection handling between the service points.

### CROSS-REFERENCE TO RELATED APPLICATION

This application is a continuation of International Application PCT/EP99/06505 having an international filing date of Sep. 3, 1999 and from which priority is claimed under all applicable sections of Title 35 of the United States Code including, but not limited to, Sections 120, 363 and 365(c).

### FIELD OF THE INVENTION

The present invention relates to a method and network element for performing switching between an incoming side and outgoing side of the network element in a telecommunication network such as a third generation mobile network.

### BACKGROUND OF THE INVENTION

In the near future, multimedia applications will in full scale enter the world of cellular communications. To support new services, which will set new demands on the infrastructure for radio communications, a new wireless communication system needs to be developed. Third-generation mobile telecommunication systems are now being determined by the global standardization work conducted by public authorities and the industry.

The role of third generation cellular systems will be to satisfy the needs for immediate access to people and information both in the office environment and globally. Requirements on the third generation cellular systems will range from basic speech services to high speed data services, both circuit switched and packet switched.

Services will be symmetric as well as asymmetric and will support applications like Internet browsing and video conferencing. It is expected that voice still will be a dominating application, so flexibility in bandwidth provision to individual users and high efficiency in bandwidth utilization is essential.

In particular, IMT 2000 (International Mobile Telephony 2000) and UMTS (Universal Mobile Telecommunication System) will open up a new spectrum with a new access method that will further serve to increase the capability of cellular systems. UMTS/IMT-2000 access will coexist with the already existing and evolved GSM access and will support full roaming and handover from one system to another, with service mapping between the two access systems.

Furthermore, packet traffic will increase significantly in the future and a packet switched base network will be required. ATM (Asynchronous Transfer Mode) technology is the coming standard as data traffic bearer and a new ATM Adaptation Layer, AAL2, has been standardized to support delay sensitive speech packets. Therefore, ATM switches have been designed for cost efficient switching as well as for transport in cellular systems. Mobile Switching Centers (MSC) handle preliminary Iu interfaces towards Radio Network Controllers (RNC) using AAL2 and AAL5 protocols, and fixed network interfaces towards ISDN (Integrated Services Digital Network), ATM LANs (Local Area Networks) and modems.

The RNCs house a radio network control function such as connection establishment and release, handover power control and radio resource handling functions. Moreover, diversity combining services, used at soft handover, and transcoding functions are also located in the RNCs. Each RNC is built on a generic ATM switch, wherein all devices and a processor of the RNC are connected to the ATM switch. Several BTSs (Base Transceiver Stations) can be connected to the RNC via ATM links.

Furthermore, IWU (Interworking Units) are provided in the mobile network in order to support connection to conventional GSM networks and other fixed circuit switched or packet switched networks.

Thus, in switching network elements, a problem arises that complexity and maintenance of call control applications increases due to the combined use of different versions of the applications in different switching techniques or different network generations.

The WO 9620448 discloses a flexible network platform and call processing system based on a logical model which provides an easy way to handle difficult (e.g. multiparty) situations. The flexible network platform is loosely coupled to a telecommunication network and provides services for subscribers, which services may be addressed by dialed numbers. The services relate to basic functionalities such as tones and the like. The logical resource model in the flexible network platform is composed of sessions, legs, virtual terminals, channels and logical resources, wherein a logical resource is an abstraction of the corresponding physical resource in the network.

Furthermore, the EP 0 765 582 discloses a resource model consisting of three layers, i.e. a network layer, a node layer and a component layer. In particular, the resource model deals with network level resources and not with resources inside a switching network element. Moreover, the resource model is an upper level resource model and does not take into account any service like tones or the like.

### SUMMARY OF THE INVENTION

It is therefore an object of the present invention to provide a flexible switching method and network element having a simplified resource management.

This object is achieved by a method for performing switching between an incoming side and an outgoing side of a switching network element in a telecommunication network, the method comprising the steps of:

allocating technology-independent identifications to a call resource of the switching element, requested by a received call;

defining an incoming logical leg and an outgoing logical leg for the received call by using the allocated identifications at the incoming side and outgoing side, respectively; and

controlling the switching operation for the received call based on the incoming logical leg and the outgoing logical leg.

Furthermore, the above object is achieved by a switching network element for performing switching between an incoming side thereof and an outgoing side thereof in a telecommunication network, the switching network element comprising:

logical resource interface means for allocating a technology-independent identification to a call resource requested by a received call; and

control means for controlling the switching operation of the switching network element on the basis of an incoming logical leg and an outgoing logical leg defined by the identifications allocated by the logical resource interface means to requested call resources at the incoming side and the outgoing side, respectively.

Accordingly, a leg concept is used to allocate the needed services to incoming and outgoing calls and, on the other hand, to hide physical resources from the visibility of the application layer. Each leg is defined by subconnections terminated at respective service points where payload and traffic parameters of the connection change. In through switch connections, several incoming legs may be defined, of which only one is connected to an outgoing direction (i.e. to achieve a macro diversity combining function). Depending on the mobility of the mobile user, the defined legs will change so that new ones will be created and old ones will be deleted. The legs are managed by a control means (leg control) which controls the reservation of service resources from corresponding resource managers and the cross-connection handling between those service points via a connection control functionality.

The logical resource interface means hides the physical resources with an abstract interface, such that a switching technology independent model is used inside the switching network element. Thereby, the problem of different switching technologies can be solved and the distributed resource management is simplified without even affecting the network operator.

Preferably, the call resources comprise at least one of a transcoding service, a macro diversity combining service, an AAL2 switching service, a tone generating service, an echo cancelling service, a compression service and a conference call service. Thereby, the above services may be switched based on service point identifications used for defining corresponding incoming an outgoing logical legs. In macro diversity combining cases, a plurality of incoming logical legs are simultaneously defined for a through connection to an outgoing logical leg. The incoming logical leg and/or the outgoing logical leg may comprise a plurality of subconnections needed for a whole through connection between said incoming and outgoing side. The plurality of subconnections depend on services requested by said received call. Thus, e.g. an AAL2 cross-connection can be integrated into an incoming or outgoing logical leg based on an AAL2 service request from the logical resource interface means. The reservation of service resources and the cross-connection handling between service points can be controlled on the basis of the incoming and outgoing logical legs. In particular, a requested resource is reserved with the same traffic parameters as reserved for a previous service in a service chain of a logical leg.

The plurality of subconnections may comprise an AAL2 connection and/or an ATM connection. The starting point of a logical leg is of an AAL2 type, if an AAL2 service is included in said logical leg.

Furthermore, the incoming and outgoing logical legs may be refreshed based on a refreshment request.

Preferably, a memory means is provided for storing data of the incoming and outgoing logical legs. Moreover, a leg identification information may be permanently stored, and a leg may be created in a start-up phase according to the defined services.

The control means may be adapted to mark and store a registration information of a leg to a client who created the leg. Then, the control means may be adapted to perform control such that only the registrated owner of a leg is allowed to request operations concerning this particular leg.

Furthermore, a connection control means may be provided for controlling a switching means in response to an output of said control means. The connection control means may comprise ATM connection control means and AAL2 connection control means. In particular, the control means may be arranged to request an AAL2 connection from said AAL2 connection control means according to a requested AAL2 service, and to control the ATM connection control means based on AAL2 connection end points received from the AAL2 connection control means.

Additionally, signal processing control means may be provided for controlling an allocation of signal processing resources to service functions based on an output of the control means. In particular, the service functions may comprise a transcoding function and a macro diversity combining function.

Furthermore, the control means may be arranged to determine necessary subconnection end points based on services required for the incoming and outgoing side according to the received call. The ATM connection control means may be arranged to supply subconnection end points to the control means based on the requested services required for the incoming and outgoing side according to the received call. The control means may be arranged to use the signal processing resource control means in order to request service end points for transcoding or macro diversity services needed for the received call. Then, the processing resource control means may be arranged to reserve resources with same traffic parameters as were reserved for a previous service in the service chain of a logical leg.

Furthermore, the ATM connection control means may be controlled by the control means to modify an ATM connection, when a starting point of a logical leg is to be modified due to a change of a bandwidth of an AAL2 subconnection.

The switching network element may be a radio network controller or an interworking network element of a third generation mobile network.

### BRIEF DESCRIPTION OF THE DRAWINGS

In the following the present invention will be described in greater detail on the basis of a preferred embodiment with reference to the accompanying drawings, in which:

FIG. 1 shows a basic block diagram of a generic ATM switch of a UMTS network according to the preferred embodiment of the present invention, and

FIG. 2 shows a functional diagram of a through switch connection relating to a macro diversity combining function.

### DESCRIPTION OF THE PREFERRED EMBODIMENT

The preferred embodiment of the switching method and network element according to the present invention will now be described on the basis of a generic ATM switch of a UMTS network.

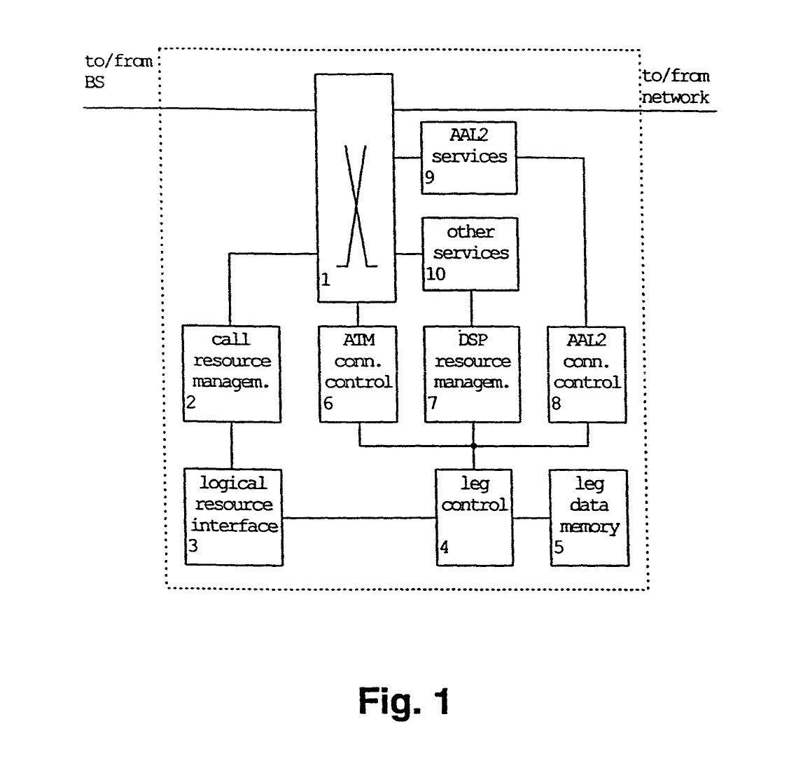

According to FIG. 1, the generic ATM switch comprises an ATM switching unit 1 which is arranged to switch connections between one or a plurality of base stations (BS) and the UMTS network. Furthermore, the ATM switch comprises an AAL2 service unit 9 which provides AAL2 service functions such as AAL2 switching or other AAL2 related resources. Additionally, a service unit 10 for other services such as transcoding, tone generation, echo cancelling, compression, announcements, conference call services, macro diversity combining services and the like is provided in the ATM switch. The AAL2 service unit 9 and the signal processing unit 10 for the other services are connected to the ATM switching unit 1 in order to be switched to the input side or the output side of the ATM switch.

According to the preferred embodiment, switching resources are abstracted using logical resources which are switching technology independent. Thus, applications, like call control, do not need to know the technology related details of the physical resources. The call level is handled by a call resource management unit 2 which provides functions like call identification, resource request/release, connecting/disconnecting calls for the applications In particular, two resources are allocated to a call, i.e. an incoming logical leg and an outgoing logical leg, which are requested by the call resource management unit 2 when a call is received. The logical legs are connected by a through connection, when speech or data signals can be transmitted.

The call resource management unit 2 is connected to a logical resource interface 3 which provides a clear, logical interface for call control and signaling to handle physical resources associated to a call, i.e. seize and release resources, e.g. logical legs. Thus, the logical resource interface 3 hides the physical resources with an abstract interface, and acts as a client for leg related requests. The logical resource interface 3 supplies a leg-related information to a leg control unit 4 arranged to manage necessary connections for the incoming and outgoing logical leg of a call, as requested by the call resource management unit 2.

Typically, a logical leg consists of several subconnections based on the requested services, e.g. AAL2 switching, transcoding, and the like. The leg control unit 4 takes care of operations related to the defined logical legs, such as creation, modification, or deletion of incoming or outgoing logical legs. The data of the defined logical legs (e.g. start and end points) and a leg connector information (e.g. number and types of subconnections) are stored in a leg data memory 5 connected to the leg control unit 4. In particular, the leg control unit 4 performs leg-related functions and refreshment functions for the receipt and response to refreshment requests related to the logical legs and the transmission of refreshment requests related to the subconnections (ATM, AAL2) of the logical legs. The refreshment information may be organized in an own table stored in the leg data memory 5, such that the leg control unit 4 may handle refreshment of e.g. 1000 legs and requests to corresponding ATM and AAL2 connections. The refreshment requests point directly to refreshment hand processes, such that they do not load a master process of the ATM switch.

The logical legs may be only defined during the call establishment. Thereby, permanent legs are not supported and therefore an MMI (Man Machine Interface) to an operator is not required.

Alternatively, permanent legs may be handled by permanently storing the leg identification information in the leg data memory 5, wherein a leg is created in the start-up phase according to the defined services. Thereby, the call set-up is accelerated, because the permanent legs can be used as a part of the through switch connection needed for a requested call. However, in this case, an operator interface is required to handle permanent legs, and resources of the network element have to be reserved even if the permanent legs are not used. The permanent legs can be saved in a disk based storage which may be comprised in the leg data memory 5 or which may be an additional internal or external memory.

The leg control unit 4 may be adapted to mark and store a registration information of a leg to a client who created the leg. The registration may give ownership to the leg, wherein only the registrated owner of the leg may then be allowed to request operations concerning this particular leg. The registration information may be modified, e.g. added later, removed or modified. Additionally, a leg creation without registration may be provided.

Based on the logical leg information obtained from the logical resource interface 3, the leg control unit 4 controls an ATM connection control unit 6, a DSP resource management unit 7 and/or an AAL2 connection control unit 8 so as to create, modify or delete corresponding leg connections according to the requirements of a received call. The ATM connection control unit 6 provides services to handle the basic operations (create, modify, state change, delete, interrogate) for external and internal interfaces and for permanent and temporary termination point resources. These resources are further the basis for operations (create, modify, state change, delete, interrogate) relating to different kinds of cross-connections, i.e. topologies (point-to-point and point-to-multi point), levels (Virtual Path Connection and Virtual Channel Connection), and types (Permanent Virtual Circuit, Switched Virtual Circuit), internally terminated and internal. The data of the resources is stored in a run-time data storage of the ATM connection control unit 6.

The leg control unit 4 receives from the ATM connection control unit 6 the necessary subconnection end points corresponding to the services required for incoming and outgoing side of a received call. The corresponding service points are reserved and the needed subconnections (internally terminated or internal) are thereafter requested by the leg control unit 4 from the ATM connection control unit 6. The ATM connection control unit 6 controls the ATM switching unit 1 according to the requested subconnections. The leg control unit 4 is responsible also for handling the modification and deletion requests related to the logical legs, which means that corresponding requests related to subconnections of the logical legs are supplied to the ATM connection control unit 6.

Furthermore, the AAL2 connection control unit 8 handles the operations related to AAL2 cross-connections and also acts as a resource manager for AAL2 related resources (AAL2 Virtual Channel Link termination points and Channel Identifiers) performed in the AAL2 service unit 9.

The leg control unit 4 uses the AAL2 connection control unit 8 to request needed AAL2 cross-connections corresponding to an AAL2 service request from the logical resource interface 3. As a feedback from the AAL2 connection control unit 8, the leg control unit 4 receives the Virtual Channel level end points of the AAL2 cross-connection to be further used for ATM subconnections of the requested logical leg.

The DSP resource management unit 7 is arranged to manage the signal processing resources of the ATM switch and offers a standard interface to the signal processing resources of the signal processing unit 10 for the other services. The service interface remains the same despite of the signal processing application. Such a centralized management also offers a dynamic way to control signal processing services and reconfigures signal processing units for new applications.

The leg control unit 4 uses the DSP resource management unit 7 to request needed service end points for transcoding and macro diversity combining services which are realized in CDSP (Configurable Dynamic Signal Processing) units of the signal processing unit 10 for the other services.

The DSP resource management unit 7 must be arranged to reserve resources with same ATM traffic parameters as were reserved for a previous service in the service chain of a logical leg. For example, the leg control unit 4 receives from the AAL2 connection control unit 8 the traffic parameters reserved for a Virtual Channel Link termination point carrying the AAL2 channel in an AAL5 format, wherein the AAL2 connection control unit 8 maps the AAL2 traffic parameters to ATM traffic parameters, and those parameters must be used for reserving a termination point (towards the AAL2 switching function) e.g. for a transcoding service via the DSP resource management unit 7. However, it should be noted that the bandwidth for termination points within a service may be different for the same through switch connection.

If a logical leg includes an AAL2 service, the starting point of the logical leg (Virtual Channel Link termination point) must be of an AAL2 type. These Virtual Channel Link termination points are created by a resource configuration function, which may be performed in the call resource management unit 2, and will be part of an internally terminated connection upon the creation of the first logical leg with the AAL2 service unit 9. If the bandwidth of the AAL2 type is to be modified, the starting point of the leg must be modified by the resource configuration, which further leads to a modification of the corresponding ATM connection by the ATM connection control unit 6. Thus, the ATM connection control unit 6 must be arranged to allow a termination point modification request even if the termination point was already connected.

In an alternative embodiment where the leg control unit 4 is implemented as a software feature, an own processing hand may be provided for each logical leg and the processing hand itself maintains the leg data. In this solution, the leg data memory 5 comprising the centralized table for the logical legs is not required. However, in this solution, the logical resource interface 3 should request the respective leg connections directly from the ATM connection control unit 6, such that the ATM related features of the ATM switch are not entirely hidden. Moreover, the amount of simultaneous leg hand processes will load the system and may lead to a bottle neck. One possible solution to this problem could be the provision of a broker unit which selects the leg identifications and maintains the table of the location of defined legs in distributed units. The leg connector function could then be performed in the broker unit, and other functions in distributed units.

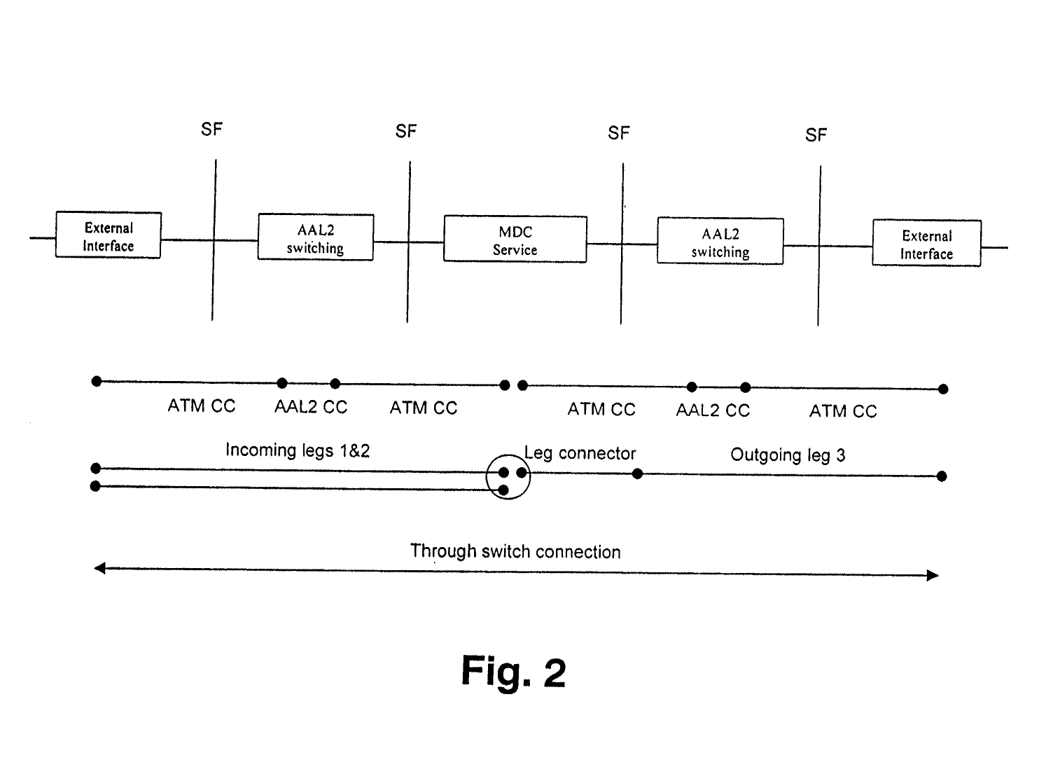

In the following, an example of a through switch connection for a macro diversity combining function is described with reference to FIG. 2.

According to FIG. 2, service functions are shown by respective blocks at the upper end of the drawing, wherein each of the service blocks is separated by a switching function (SF) performed by the ATM switching unit 1. In the next lower row of the drawing, the corresponding connection control units controlling the service or switching function are indicated. Then, the defined incoming and outgoing legs and a leg connector are shown.

In the present example, two incoming and one outgoing leg are requested by the call resource management unit 2. Moreover, a through switch connection with an AAL2 switching function and a macro diversity combining (MDC) service for two incoming calls are specified by the call resource management unit 2. Based on this resource information, the logical resource interface 3 supplies a corresponding leg-related request defining two incoming comprising an AAL2 switching function and a subsequent MDC service, and an outgoing leg comprising an AAL2 switching function to the outgoing side of the ATM switch.

The leg control unit 4 receives the leg-related request from the logical resource interface 3 and obtains the necessary subconnection end points from the ATM connection control unit 6, the DSP resource management unit 7 and the AAL2 connection control unit 8 based on the services required for the incoming and outgoing side of the through switch connection. The obtained data of the incoming legs and the outgoing legs are stored in the leg data memory 5. Then, the subconnection end points are reserved and requested such that the ATM connection control unit 6 controls the ATM switching unit 1 so as to connect an external interface to the AAL2 switching service point of the AAL2 service unit 9. The AAL2 connection control unit 8 controls the AAL2 service unit 9 so as to establish an internal AAL2 switching subconnection, wherein the ATM connection control unit 6 establishes an ATM subconnection from the service end point of the AAL2 service unit 9 to a service end point of the signal processing service unit 10, as defined by the respective incoming logical leg. Additionally, a similar second incoming logical leg is defined for the second connection to be combined to the first connection by the macro diversity combining function. Furthermore, an outgoing leg is established comprising an ATM subconnection switches between the service end point of the signal processing service unit 10 providing the MDC service and the service end point of the AAL2 switching service end point.

Furthermore, the AAL2 connection control unit 8 controls the AAL2 service unit 9 so as to perform an AAL2 switching function, and the ATM connection control unit 6 controls the ATM switching unit 1 so as to establish a subconnection between the service end point of the AAL2 service unit 9 and a respective external interface at the outgoing side of the ATM switch. Accordingly, two incoming legs 1 and 2, and one outgoing leg 3 are handled by the leg control unit 4 in order to establish the through switch connection, wherein a leg connector is defined by the leg control unit 4 so as to connect the outgoing leg 3 to the incoming leg selected by the macro diversity combining service.

It is to be noted that the switching method and network element described in the preferred embodiment can be applied in any telecommunication network providing a switching function. In particular, the switching network element may be a Radio Network Controller (RNC), an MSC or an IWU network element of a mobile network, such as the GSM or the UMTS network. Alternatively, the network element may be used in a network between switching planes and adaptation planes e.g. in the “Multi Switching Forum”.

The call resources of the switching network element may be identified by any technology-independent identification, such as an identification number, name, address, or the like. Furthermore, the units 6 to 8 depicted in FIG. 1 may be implemented as discrete hardware arrangements or circuits, or may be implemented as software programs controlling a processor or computer system. The above description of the preferred embodiment and the accompanying drawings are only intended to illustrate the present invention. The preferred embodiment of the invention may vary within the scope of the attached claims.

In summary, the present invention relates to a switching method and network element for performing switching between an incoming side and an outgoing side of the network element, wherein a technology-independent identification is allocated to a call resource of a switching network element, requested by a received call. Then, an incoming logical leg and an outcoming logical leg for the received call are defined by using the allocated identifications, and the switching operation for the received call is controlled on the basis of the incoming logical leg and the outgoing logical leg. Thus, physical resources of the switching network element are hidden from the visibility of the application layer. Through switch connections through the switching network element thus consist of several subconnections terminated at service points where the payload and traffic parameters of the connection will change. Depending on the mobility of the mobile user, the logical legs will change so that new ones will be created and old ones will be deleted. The logical legs are managed by a leg control unit which controls the reservation of the service resources from corresponding resource management units and the cross-connection handling between the service points. Thereby, the complexity and maintenance of call control applications is reduced, since logical resources are handled and there is no need for different versions of the applications in different switching techniques.

1. A method for performing switching between an incoming side and an outgoing side of a switching network element in a telecommunication network, said method comprising the steps of:
a) allocating technology-independent identifications to a call resource of said switching network element, requested by a received call;
b) defining an incoming logical leg and an outgoing logical leg for said received call by using said allocated identifications for said incoming side and said outgoing side, respectively, and
c) controlling the switching operation for said received call based on said incoming logical leg and said outgoing logical leg.

2. A method according to claim 1, wherein said call resources comprise at least one of a transcoding service, a macro diversity combining service, an AAL2 switching service, a tone generating service, an echo cancelling service, a compression service and a conference call service.

3. A method according to claim 1, wherein a plurality of incoming logical legs are simultaneously defined for a through connection to an outgoing logical leg.

4. A method according to claim 1, wherein said incoming logical leg and/or said outgoing logical leg comprise a plurality of subconnections needed for a whole through-connection between said incoming side and said outgoing side.

5. A method according to claim 4, wherein said plurality of subconnections depend on services requested by said received call.

6. A method according to claim 1, wherein a reservation of service resources and a cross-connection handling between service points is controlled on the basis of said incoming and outgoing logical legs.

7. A method according to claim 6, wherein resources are reserved with the same traffic parameters as reserved for a previous service in a service chain of a logical leg.

8. A method according to claim 4, wherein said plurality of subconnections comprise an AAL2 connection and/or an ATM connection.

9. A method according to claim 1, wherein a signal processing resource for providing service functions is managed based on said incoming and outgoing logical legs.

10. A method according to claim 1, wherein data of said incoming and outgoing logical legs is stored in a memory.

11. A switching network element according to claim 10, wherein a leg identification information is permanently stored and a leg is created in a start-up phase according to the defined services.

12. A method according to claim 11, wherein the starting point of a logical leg is of an AAL2 type, if an AAL2 service is included in said logical leg.

13. A method according to claim 1, wherein said incoming and outgoing logical legs are refreshed based on a refresh request.

14. A switching network element for performing switching between an incoming side thereof and an outgoing side thereof in a telecommunication network, said switching network element comprising:
a) logical resource interface means (3) for allocating a technology-independent identification to a call resource requested by a received call; and
b) control means (4) for controlling the switching operation of said switching network element on the basis of an incoming logical leg and an outgoing logical leg defined by the identifications allocated by said logical resource interface means (3) to requested call resources at said incoming side and said outgoing side, respectively.

15. A switching network element according to claim 14, further comprising memory means (5) for storing data of said incoming and outgoing logical legs.

16. A switching network element according to claim 14, wherein said control means (4) are adapted to mark and store a registration information of a leg to a client who created the leg.

17. A switching network element according to claim 16, wherein said control means (4) is adapted to perform control such that only the registrated owner of a leg is allowed to request operations concerning this particular leg.

18. A network element according to claim 14, further comprising connection control means (6, 8) for controlling a switching means (1, 9) in response to an output of said control means (4).

19. A switching network element according to claim 18, wherein said connection control means (6, 8) comprises ATM connection control means (6) and AAL2 connection control means (8).

20. A switching network element according to claim 19, wherein said control means (4) is arranged to request an AAL2 connection from said AAL2 connection control means (6) according to a requested AAL2 service, and to control said ATM connection control means (6) based on AAL2 connection end points received from said AAL2 connection control means (6).

21. A switching network element according to claim 14, further comprising signal processing control means (7) for controlling an allocation of signal processing resources to service functions based on an output of said control means (4).

22. A switching network element according to claim 21, wherein said service functions comprise at least one of transcoding, tone generation, echo cancelling, compression, announcements, conference call services and macro diversity combining services.

23. A switching network element according claim 14, wherein said control means (4) is arranged to determine necessary subconnection end points based on services required for said incoming and outgoing side according to said received call.

24. A switching network element according to claim 19, wherein said ATM connection control means (6) is arranged to supply subconnection end points to said control means (4) based on requested services required for said incoming and outgoing side according to said received call.

25. A switching network element according to claim 21, wherein said control means (4) is arranged to use said signal processing resource control means (7) in order to request service end points for transcoding or macro diversity services needed for said received call.

26. A switching network element according to claim 21, wherein said processing resource control means (7) is arranged to reserve resources with same traffic parameters as were received for a previous service in the service chain of a logical leg.

27. A switching network element according to claim 19, wherein said ATM connection control means (6) is controlled by said control means (4) to modify an ATM connection, when a starting point of a logical leg is to be modified due to a change of a bandwidth of an AAL2 subconnection.

28. A switching network element according to claim 14, wherein said switching element is a radio network controller or an interworking network element of a third generation mobile network.
